(19) United States
(12) Patent Application Publication
(10) Pub. No.: US 2008/0257119 A1
(43) Pub. Date: Oct. 23, 2008

(54) Lug bolt wrench with step pad

(76) Inventor: Andrew McCartney, Sunland, CA (US)

Correspondence Address: Cislo & Thomas LLP, 1333 2nd Street, Suite #500, Santa Monica, CA, 90401-4110, US

(21) Appl. No.: 12/151,802

(22) Filed: May 9, 2008

Related U.S. Application Data
(63) Continuation-in-part of application No. 29/292,205, filed on Oct. 1, 2007.
Application No. 29/292,205 is a continuation-in-part of application No. 29/257,081, filed on Mar. 28, 2006, now Pat. No. D551926.

(51) Int. Cl. B25B 13/48; B23P 17/00

(52) U.S. Cl. 81/180.1; 29/592

(57) ABSTRACT

A wrench for handling a fastener, involving an elongated member with a proximal end and a distal end, a step pad being disposed proximate the elongated member proximal end and for providing additional torque, and an adapter being disposed proximate the elongated member distal end. The adapter may include an element, such as a socket member and a ratchet member. The elongated member distal end may include a tool member.

### CROSS-REFERENCE TO RELATED APPLICATION(S)

This document is a continuation-in-part application that is related to, and claims priority through, U.S. Design patent application Ser. No. 29/292,205, filed on Oct. 1, 2007, also entitled “Lug Bolt Wrench with Step Pad,” that is, in turn, related to, and claims priority from, U.S. Design patent application Ser. No. 29/257,081, filed on Mar. 28, 2006, also entitled “Lug Bolt Wrench with Step Pad,” now issued as U.S. Design Pat. No. D551,926 on Oct. 2, 2007, all the subject matter of which are incorporated herein in their entirety by reference.

### TECHNICAL FIELD

The present invention technically relates to motor vehicle tools. More particularly, the present invention technically relates to tools for servicing wheels, tires, and brakes of a motor vehicle. Even more particularly, the present invention technically relates to tools for removing and tightening the lug bolts of the wheels of a motor vehicle.

### BACKGROUND ART

Various devices for removing and tightening lug bolts have been available in the related art. One such invention is the conventional lug bolt wrench or tire iron comprising crossbars having integrally formed sockets for accommodating only four sizes of lug bolts. Other related art inventions include a conventional crescent wrench, having a fixed size, a ratchet having a socket for accommodating the head of a lug bolt, and the like. Channel locks may be used for removing lug bolts, but they are impractical in that maneuvering them around, various wheel configurations may be difficult. However, these related art inventions are further difficult to use for large lug bolts as are found on large heavy motor vehicles, such as tractor-trailers for inland freight. Such lug bolts are installed using substantial torque and are removed using substantial impact. Thus, these lug bolts are difficult to service without an air-assisted impact wrench which would be available in a typical service garage. However, in the field or on the road, an air-assisted impact wrench would not usually be available. Accordingly, a long-felt need remains for a wrench that be used in the field or on the road which provides sufficient torque and impact for removing and replacing lug bolts with respect to motor vehicles, especially heavy duty motor vehicles.

### DISCLOSURE OF THE INVENTION

The present invention involves a wrench for handling a fastener, e.g., a heavy duty lug bolt from a wheel of a motor vehicle, e.g., a tractor trailer, in the field or on the road. The present invention wrench generally comprises an elongated member having a proximal end and a distal end, a step pad being disposed proximate the elongated member proximal end and for providing additional impact and torque, and an adapter being disposed proximate the elongated member distal end. The adapter comprises an element, such as a socket member and a ratchet member. The elongated member distal end comprises a tool member.

The present invention also involves a method of fabricating a wrench for handling a fastener, as discussed, supra. The present invention fabrication method generally comprises the steps of providing an elongated member having a proximal end and a distal end, providing a step pad being disposed proximate the elongated member proximal end and for providing additional impact and torque, and providing an adapter being disposed proximate the elongated member distal end. The fabrication method further comprises the steps of providing the adapter as an element, such as a socket member and a ratchet member, and providing the elongated member distal end with a tool member.

The present invention further involves a method of handling a fastener by way of a wrench, as discussed, supra. The present invention handling method generally comprises the steps of providing an elongated member having a proximal end and a distal end, providing a step pad being disposed proximate the elongated member proximal end and for providing additional impact and torque, and providing an adapter being disposed proximate the elongated member distal end, disposing the adapter onto the fastener, and applying a force onto the step pad by a user's foot, thereby loosening the fastener from, or tightening the fastener to, the wheel. These and other aspects of the invention will become apparent from a review of the accompanying drawings and the section entitled “Mode(s) for Carrying-Out the Invention,” infra.

### BRIEF DESCRIPTION OF THE DRAWING(S)

For a better understanding of the present invention, reference is made to the below-referenced description of the accompanying Drawing. Reference numbers refer to the same or equivalent parts of the present invention throughout the several figures of the Drawing.

FIG. 1 is a perspective view of a wrench, comprising an adapter for handling a fastener, such as a lug bolt as would be used on a heavy motor vehicle, and a step pad for facilitating provision of additional impact and torque, in accordance with a first exemplary embodiment of the present invention.

FIG. 2 is a top view of an adapter, as shown in FIG. 1, in accordance with the first exemplary embodiment of the present invention.

FIG. 3 is a bottom view of an adapter, as shown in FIG. 1, in accordance with the first exemplary embodiment of the present invention.

FIG. 4 is a side view of a wrench, as shown in FIG. 1, in accordance with the first exemplary embodiment of the present invention.

FIG. 5 is a front view of a wrench, as shown in FIG. 1, in accordance with the first exemplary embodiment of the present invention.

FIG. 6 is an opposing side view of a wrench, as shown in FIG. 1, in accordance with the first exemplary embodiment of the present invention.

FIG. 7 is a perspective view of a wrench, comprising an adapter for handling a fastener, such as a lug bolt as would be used on a heavy motor vehicle, and a step pad for facilitating provision of additional impact and torque, in accordance with a second exemplary embodiment of the present invention.

FIG. 8 is a rear view of a wrench, as shown in FIG. 7, in accordance with the second exemplary embodiment of the present invention.

FIG. 9 is a front view of a wrench, as shown in FIG. 7, in accordance with the second exemplary embodiment of the present invention.

FIG. 10 is a side view of a wrench, as shown in FIG. 7, in accordance with the second exemplary embodiment of the present invention.

FIG. 11 is an opposing side view of a wrench, as shown in FIG. 7, in accordance with the second exemplary embodiment of the present invention.

FIG. 12 is a bottom view of a wrench, as shown in FIG. 7, in accordance with the second exemplary embodiment of the present invention.

FIG. 13 is a top view of a wrench, as shown in FIG. 7, in accordance with the second exemplary embodiment of the present invention.

FIG. 14 is a perspective view of a wrench, comprising an adapter for handling a fastener, such as a lug bolt as would be used on a heavy motor vehicle, and a step pad for facilitating provision of additional impact and torque, in accordance with a third exemplary embodiment of the present invention.

FIG. 15 is a front view of a wrench, as shown in FIG. 14, in accordance with the third exemplary embodiment of the present invention.

FIG. 16 is a rear view of a wrench, as shown in FIG. 14, in accordance with the third exemplary embodiment of the present invention.

FIG. 17 is a side view of a wrench, as shown in FIG. 14, in accordance with the third exemplary embodiment of the present invention.

FIG. 18 is an opposing side view of a wrench, as shown in FIG. 14, in accordance with the third exemplary embodiment of the present invention.

FIG. 19 is a bottom view of an adapter, as shown in FIG. 14, in accordance with the third exemplary embodiment of the present invention.

FIG. 20 is a top view of an adapter, as shown in FIG. 14, in accordance with the third exemplary embodiment of the present invention.

### MODE(S) FOR CARRYING-OUT THE INVENTION

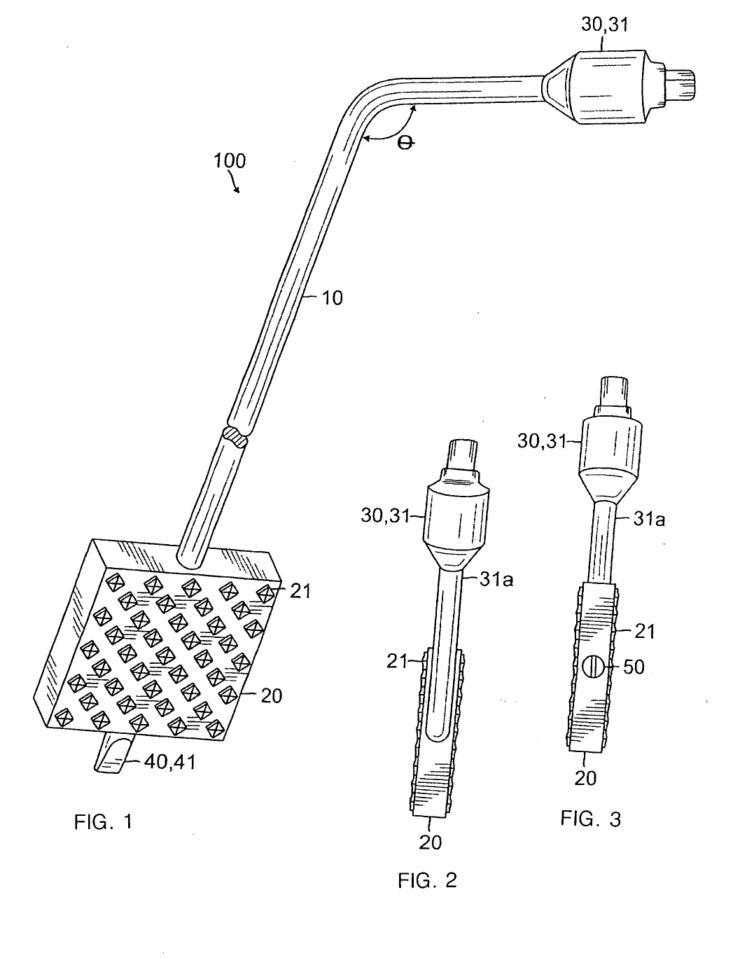

FIG. 1 is a perspective view of a wrench 100 with a step pad 20 for handling a fastener (not shown), such as a lug bolt (not shown) as would be used on a heavy motor vehicle (not shown), in accordance with a first exemplary embodiment of the present invention. The wrench 100 generally comprises an elongated member 10 having a proximal end 10a and a distal end 10b, a step pad 20 being disposed proximate the elongated member proximal end 10a and for providing additional impact and torque, and an adapter 30 being disposed proximate the elongated member distal end 10b. The adapter 30 comprises an element, such as a socket member 31 and a ratchet member 32. The elongated member distal end 10b comprises a tool member 40. The elongated member 10 comprises a bend for facilitating disposing the adapter 30 onto the fastener, wherein the bend comprises an angle theta in a range of approximately 0° to approximately 180°, preferably in a range of approximately 90° to approximately 120° (See also FIG. 14).

Referring to FIGS. 1, 7, and 14, the step pad 20 comprises a configuration, such as a polygonal shape, a square shape, a rectangular shape, a triangular shape, a curved shape, a circular shape, and an elliptical shape. The step pad 20 comprises a raised feature 21 for providing additional friction for a user's foot (not shown), wherein the raised feature 21 comprises an element selected such as a tread distribution, a diamond-shaped tread distribution, a herringbone-shaped tread distribution, and an oblique channel-shaped tread distribution.

FIG. 2 is a top view of an adapter 30, comprising a socket member 31, as shown in FIG. 1, in accordance with the first exemplary embodiment of the present invention. The socket member 31 comprises a stem 31a for telescoping the socket member 31 from the elongated member distal end 10b.

FIG. 3 is a bottom view of an adapter 30, as shown in FIG. 1, in accordance with the first exemplary embodiment of the present invention. The wrench 100 further comprises an adjusting member 50 for disposing the socket member 31 in relation to the elongated member 10. The adjusting member 50 comprises an element such as a screw, a set screw, a pin member.

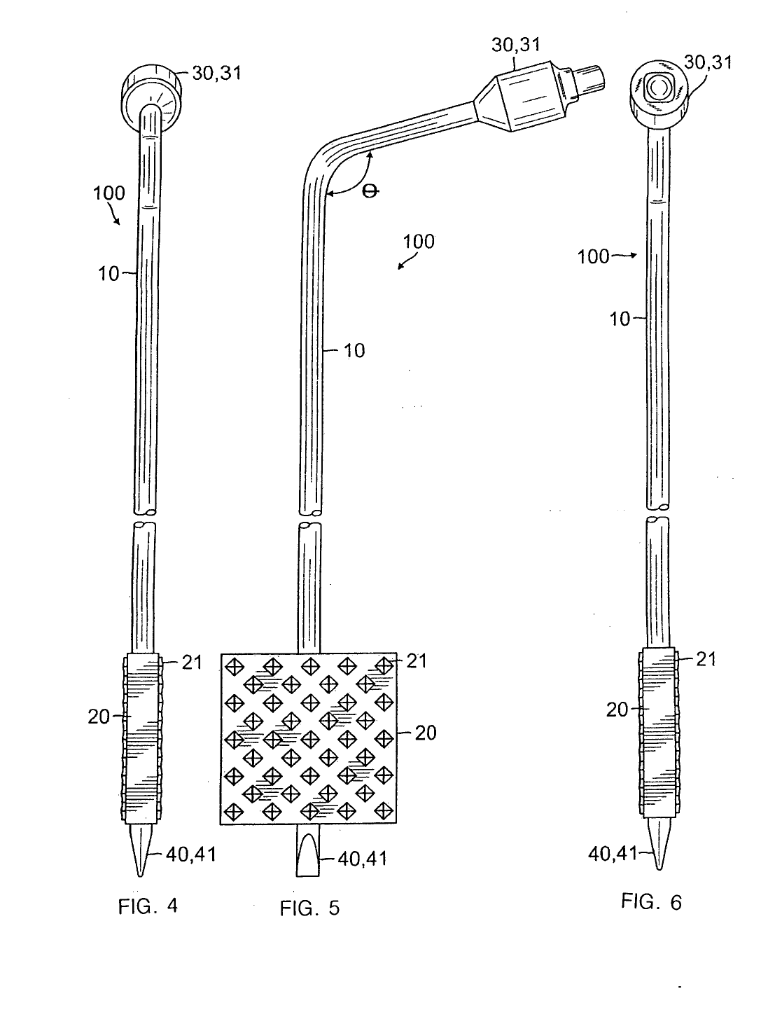

FIG. 4 is a side view of a wrench 100, as shown in FIG. 1, in accordance with the first exemplary embodiment of the present invention. The projection of the raised feature 21 is shown in relation to the step pad 20. The tool member 40 comprises a flathead screwdriver 41, by example only. The tool member 40 is provided in the event that other tools may be needed in the field or on the road.

FIG. 5 is a front view of a wrench 100, as shown in FIG. 1, in accordance with the first exemplary embodiment of the present invention. The tool member 40 comprises an element such as a screwdriver, a flathead screwdriver 41 (See FIG. 4), a Phillips screwdriver, a hexagonal head screwdriver, and a prying member 42 (See also FIG. 14).

FIG. 6 is an opposing side view of a wrench 100, as shown in FIG. 1, in accordance with the first exemplary embodiment of the present invention. The socket member 31 comprises a configuration for accommodating at least one fastener size and at least one fastener shape. The socket member 31 may be integrally formed with the elongated member 10.

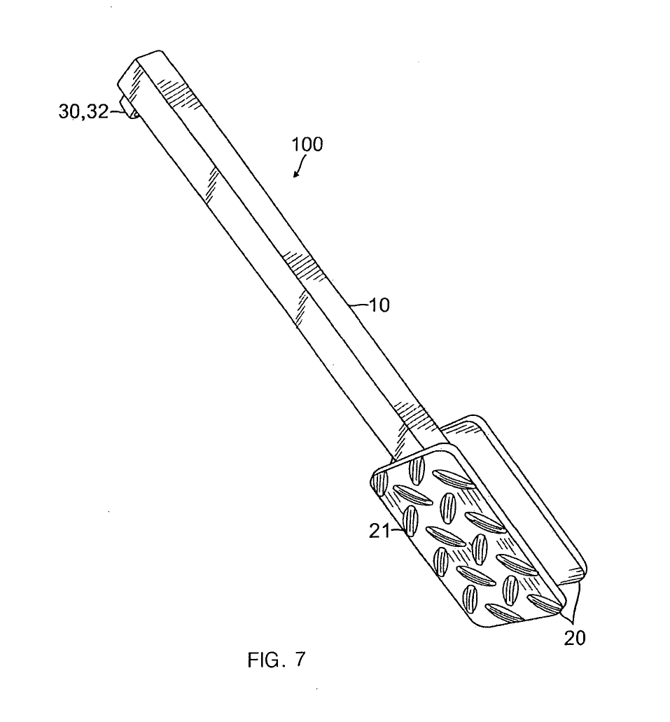

FIG. 7 is a perspective view of a wrench 100 with a step pad 20 for handling a fastener (not shown), in accordance with a second exemplary embodiment of the present invention. The step pad 20 may be integrally formed with the elongated member 10. The step pad 20 may comprise a pair of plates sandwiching the elongated member 10. The ratchet member 32 may comprise a configuration such as a square cross-section, by example only.

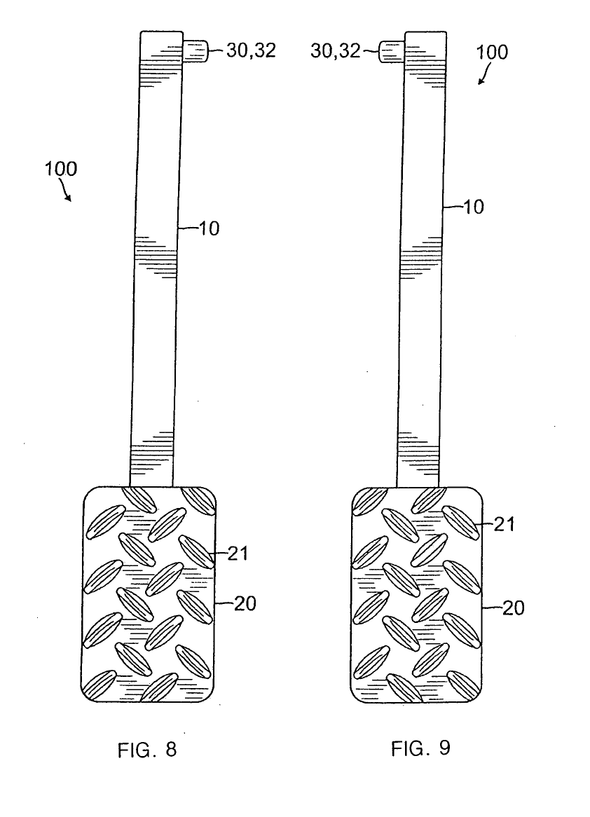

FIG. 8 is a rear view of a wrench 100, as shown in FIG. 7, in accordance with the second exemplary embodiment of the present invention. The raised feature 21 comprises a herringbone pattern, by example only.

FIG. 9 is a front view of a wrench 100, as shown in FIG. 7, in accordance with the second exemplary embodiment of the present invention. The ratchet member 32 may comprise any cross-sectional configuration for accommodating any given lug bolt shape.

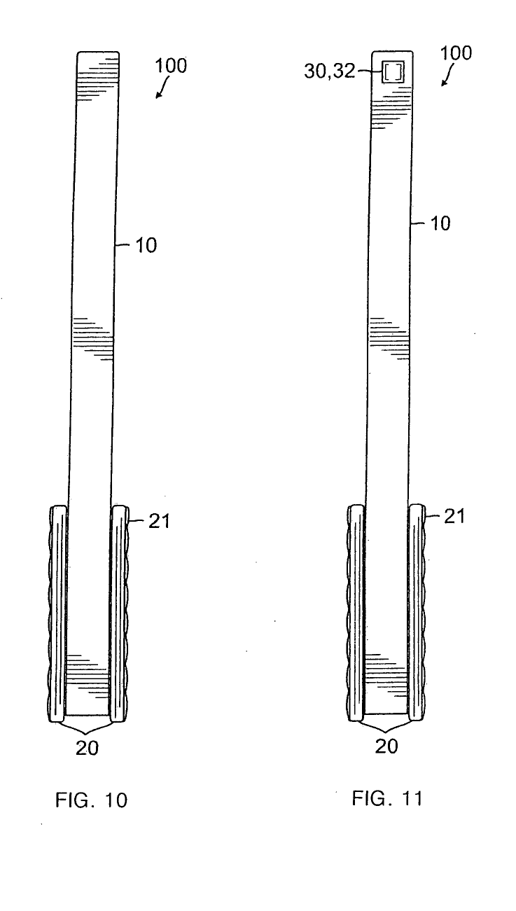

FIG. 10 is a side view of a wrench 100, as shown in FIG. 7, in accordance with the second exemplary embodiment of the present invention. The raised feature 21 is shown in relation to the step pad 20, the step pad 20 comprising a pair of plates, by example only.

FIG. 11 is an opposing side view of a wrench 100, as shown in FIG. 7, in accordance with the second exemplary embodiment of the present invention. The ratchet member 32 is shown having a square cross-section, by example only. The ratchet member 32 may comprise any cross-section for adapting any given lug bolt shape.

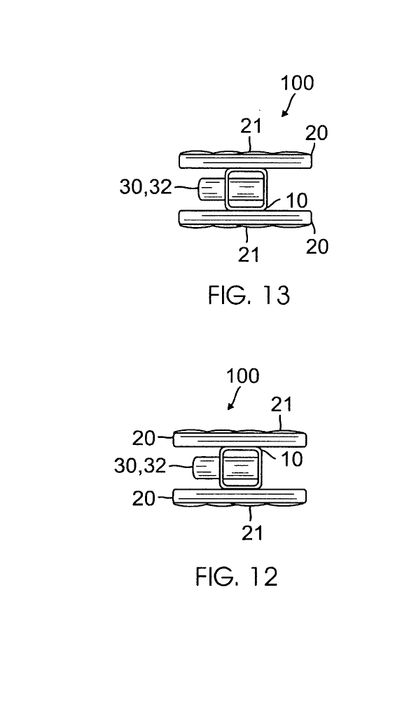

FIG. 12 is a bottom view of a wrench 100, as shown in FIG. 7, in accordance with the second exemplary embodiment of the present invention. The ratchet member 32 may be integrally formed with the elongated member 10.

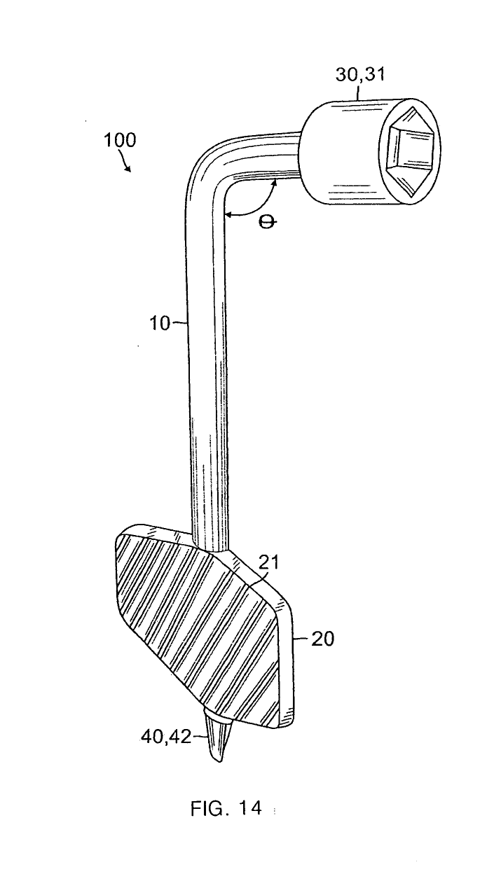

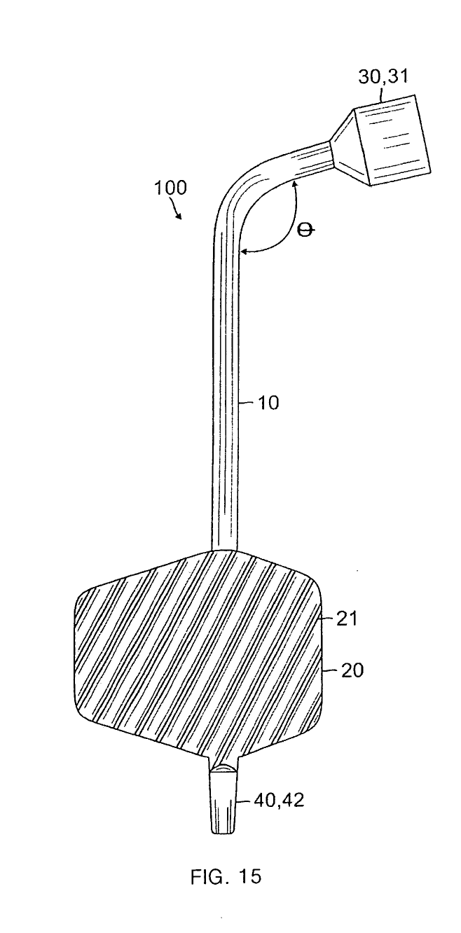

FIG. 13 is a top view of a wrench 100, as shown in FIG. 7, in accordance with the second exemplary embodiment of the present invention. The ratchet member 32 may alternatively be separately formed and disposed through corresponding tap holes of the elongated member 10.

FIG. 14 is a perspective view of a wrench 100, comprising an adapter 30 for handling a fastener (not shown) and a step pad 20 for facilitating the provision of additional impact and torque, in accordance with a third exemplary embodiment of the present invention. The prying member 42 facilitates removal of a hubcap (not shown) from a wheel (not shown), e.g., in a crowbar manner. The elongated member 10 may comprise a bend, wherein the bend comprises an angle theta in a range of approximately 0° to approximately 180°, preferably approximately 90°, by example only, for the third embodiment.

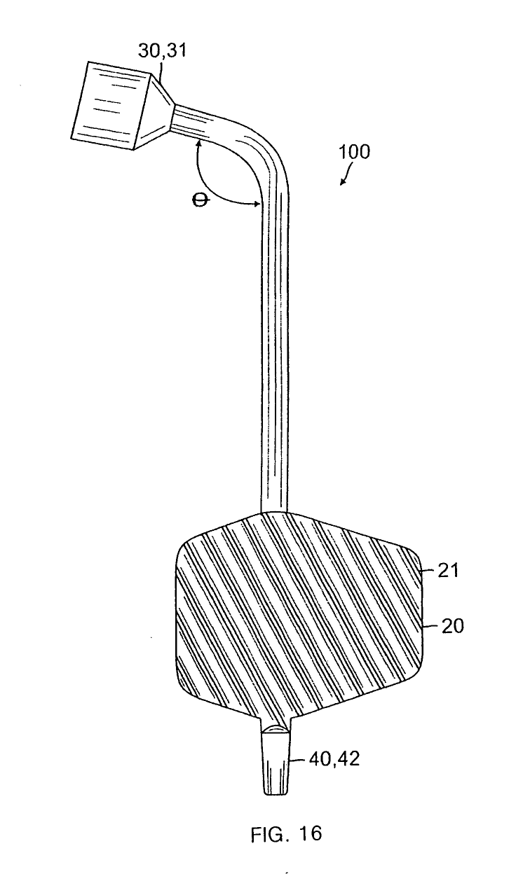

FIG. 15 is a front view of a wrench 100, as shown in FIG. 14, in accordance with the third exemplary embodiment of the present invention. The step pad 20 comprises a polygonal shape, by example only. The raised feature 21 comprises a tread distribution.

FIG. 16 is a rear view of a wrench 100, as shown in FIG. 14, in accordance with the third exemplary embodiment of the present invention. The bend angle theta may alternatively comprise an oblique angle.

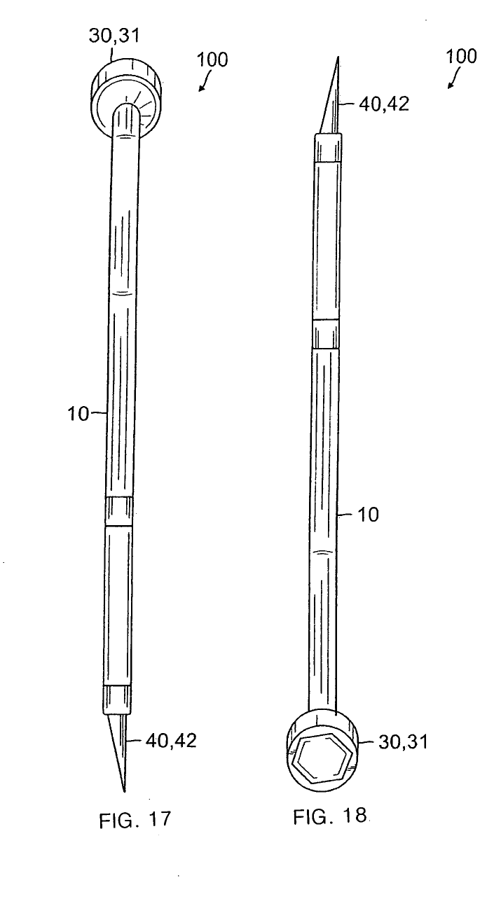

FIG. 17 is a side view of a wrench 100, as shown in FIG. 14, in accordance with the third exemplary embodiment of the present invention. The tool 40 comprises a prying member 42 for facilitating removal of hubcaps and the like.

FIG. 18 is an opposing side view of a wrench 100, as shown in FIG. 14, in accordance with the third exemplary embodiment of the present invention. The adapter 30 comprises a socket member 31 having a configuration that accommodates any lug bolt shape.

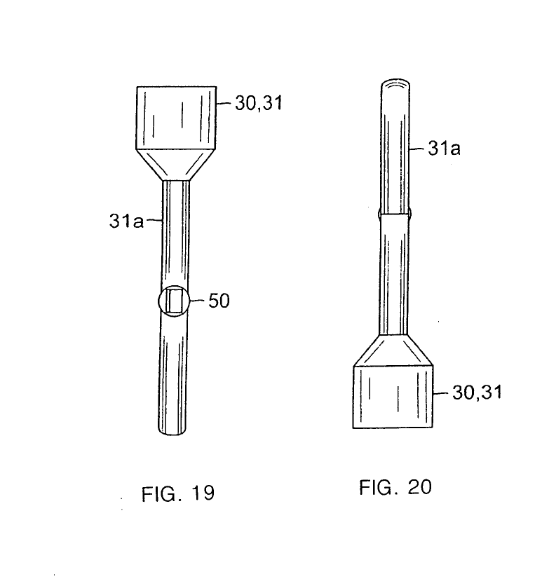

FIG. 19 is a bottom view of a wrench 100, as shown in FIG. 14, in accordance with the third exemplary embodiment of the present invention. The adjusting member 50 comprises a pin member, by example only.

FIG. 20 is a top view of a wrench 100, as shown in FIG. 14, in accordance with the third exemplary embodiment of the present invention. The pin member may be selectably disposed through, and registering, corresponding tap holes of the stem 31a and the elongated member 10.

The present invention also involves a method M₁ of fabricating a wrench 100 for handling a fastener (not shown), as discussed, supra. The present invention fabrication method M₁ generally comprises the steps of providing an elongated member 10 having a proximal end 10a and a distal end 10b, providing a step pad 20 being disposed proximate the elongated member proximal end 10a and for providing additional impact and torque, and providing an adapter 30 being disposed proximate the elongated member distal end 10b. The fabrication method M₁ further comprises the steps of providing the adapter 30 as an element, such as a socket member 31 and a ratchet member 32, and providing the elongated member distal end 10b with a tool member 40.

The present invention further involves a method M₂ of handling a fastener (not shown) by way of a wrench 100, as discussed, supra. The present invention handling method M₂ to generally comprises the steps of providing an elongated member having 10 a proximal end 10a and a distal end 10b, providing a step pad 20 being disposed proximate the elongated member proximal end and 10a for providing additional impact and torque, and providing an adapter 30 being disposed proximate the elongated member distal end 10b, disposing the adapter 30 onto the fastener, and applying a force onto the step pad 20 by a user's foot, thereby loosening the is fastener from, or tightening a fastener to, the wheel.

Information, as herein shown and described in detail, is fully capable of attaining the above-described object of the invention. The presently preferred embodiment of the invention, is, thus, representative of the subject matter which is broadly contemplated by the present invention. The scope of the present invention also fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem that is sought to be resolved by the present invention, for such to be encompassed by the present claims. Furthermore, no element, component, or method step in the present disclosure is intended to be dedicated to the public, regardless of whether the element, component, or method step is explicitly recited in the claims. However, that various changes and modifications, in form, material, and fabrication material detail, may be made, without departing from the spirit and scope of the invention as set forth in the appended claims, should be readily apparent to those of ordinary skill in the art as being encompassed by the present invention. No claim herein is to be construed under the provisions of 35 U.S.C. § 112, sixth paragraph, unless the element is expressly recited using the phrase “means for.”

### INDUSTRIAL APPLICABILITY

The present invention industrially applies to motor vehicle tools. More particularly, the is present invention industrially applies to tools for servicing wheels, tires, and brakes of a motor vehicle. Even more particularly, the present invention industrially applies to tools for removing and tightening the lug bolts of the wheels of a motor vehicle.

What is claimed:

1. A wrench for handling a fastener, comprising:
an elongated member having a proximal end and a distal end;
a step pad being disposed proximate the elongated member proximal end and for providing additional torque; and
an adapter being disposed proximate the elongated member distal end.

2. A wrench, as recited in claim 1, wherein the adapter comprises at least one element selected from a group consisting essentially of a socket member and a ratchet member.

3. A wrench, as recited in claim 1, wherein elongated member distal end comprises a tool member.

4. A wrench, as recited in claim 3, wherein the tool member comprises at least one element selected from a group consisting essentially of a screwdriver, a flathead screwdriver, a Phillips screwdriver, a hexagonal head screwdriver, and a prying member.

5. A wrench, as recited in claim 1, wherein the step pad comprises at least one configuration selected from a group consisting essentially of a polygonal shape, a square shape, a rectangular shape, a triangular shape, a curved shape, a circular shape, and an elliptical shape.

6. A wrench, as recited in claim 1, wherein the step pad comprises a raised feature for providing additional friction for a user's foot.

7. A wrench, as recited in claim 6, wherein the raised feature comprises at least one element selected from a group consisting essentially of a tread distribution, a diamond-shaped tread distribution, a herringbone-shaped tread distribution, and an oblique channel-shaped tread distribution.

8. A wrench, as recited in claim 2, wherein the socket member comprises a stem for telescoping the socket member from the elongated member distal end.

9. A wrench, as recited in claim 8, further comprising an adjusting member for disposing the socket member in relation to the elongated member.

10. A wrench, as recited in claim 9, wherein the elongated member comprises a bend for facilitating disposing the adapter onto the fastener.

11. A wrench, as recited in claim 10, wherein the bend comprises an angle in a range of approximately 0° to approximately 180°.

12. A wrench, as recited in claim 9, wherein adjusting member comprises at least one element selected from a group consisting essentially of a screw, a set screw and a pin member.

13. A wrench, as recited in claim 2, wherein the socket member comprises at least one configuration for accommodating at least one fastener size.

14. A wrench, as recited in claim 2, wherein the socket member is integrally formed with the elongated member.

15. A wrench, a recited in claim 1, wherein the step is integrally formed with the elongated member.

16. A wrench, as recited in claim 1, wherein the step pad comprises a pair of plates sandwiching the elongated member.

17. A wrench, as recited in claim 4, wherein the prying member facilitates removal of a hubcap from a wheel.

18. A wrench, as recited in claim 4, wherein the ratchet member comprises a square cross-section.

19. A wrench, as recited in claim 2, further comprising an adjusting member for disposing the socket member in relation to the elongated member,
wherein elongated member distal end comprises a tool member,
wherein the tool member comprises at least one element selected from a group consisting essentially of a screwdriver, a flathead screwdriver, a Phillips screwdriver, a hexagonal head screwdriver, and a prying member,
wherein the step pad comprises at least one configuration selected from a group consisting essentially of a polygonal shape, a square shape, a rectangular shape, a triangular shape, a curved shape, a circular shape, and an elliptical shape,
wherein the step pad comprises a raised feature for providing additional friction for a user's foot,
wherein the raised feature comprises at least one element selected from a group consisting essentially of a tread distribution, a diamond-shaped tread distribution, a herringbone-shaped tread distribution, and an oblique channel-shaped tread distribution,
wherein the socket member comprises a stem for telescoping the socket member from the elongated member distal end,
wherein the elongated member comprises a bend for facilitating disposing the adapter onto the fastener,
wherein the bend comprises an angle in a range of approximately 0° to approximately 180°,
wherein adjusting member comprises at least one element selected from a group consisting essentially of a screw, a set screw and a pin member,
wherein the socket member comprises at least one configuration for accommodating at least one fastener size,
wherein the socket member is integrally formed with the elongated member,
wherein the step is integrally formed with the elongated member,
wherein the step pad comprises a pair of plates sandwiching the elongated member, and
wherein the prying member facilitates removal of a hubcap from a wheel.

20. A method of fabricating a wrench for handling a fastener, comprising the steps of:
providing an elongated member having a proximal end and a distal end;
providing a step pad being disposed proximate the elongated member proximal end and for providing additional torque; and
providing an adapter being disposed proximate the elongated member distal end.

21. A method of handling a fastener by way of a wrench, comprising the steps of:
providing an elongated member having a proximal end and a distal end;
providing a step pad being disposed proximate the elongated member proximal end and for providing additional torque; and
providing an adapter being disposed proximate the elongated member distal end;
disposing the adapter onto the fastener;
applying a force onto the step pad by a user's foot, the force being selected from a group consisting essentially of a tightening force and a loosening force.
